(19) United States
(12) Patent Application Publication
(10) Pub. No.: US 2008/0044126 A1
(43) Pub. Date: Feb. 21, 2008

(54) Integrated Optical Waveguide Structure with Low Coupling Losses to an External Optical Field

(76) Inventors: Raffaella Costa, Milano (IT); Giuseppe Cusmai, Milano (IT); Andrea Melloni, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/566,948

(22) PCT Filed: Aug. 4, 2003
(86) PCT No.: PCT/EP03/08613

§ 371 Date: Nov. 21, 2006

(51) Int. Cl. G02B 6/12

(52) U.S. Cl. 385/14

(57) ABSTRACT

An integrated optical waveguide structure having a waveguide core for guiding an optical field, formed on a lower cladding layer. The waveguide core has a waveguide core layer substantially coextensive to the lower cladding layer and having a substantially uniform thickness, and a waveguide core rib of a substantially uniform height protruding from a surface of the waveguide core layer opposite to a surface thereof facing the lower cladding layer. A layout of the waveguide core rib defines a path for the guided optical field. The integrated optical waveguide structure has a circuit waveguide portion in which the waveguide core layer has a first width, adapted for guiding the optical field through an optical circuit, and at least one coupling waveguide portion adapted for coupling the circuit waveguide portion to an external optical field. The coupling portion has a terminal waveguide core rib portion having a second width lower than the first width and terminating in a facet, and a transition waveguide core rib portion optically joining to each other the circuit waveguide portion and the terminal waveguide portion, the transition waveguide core rib portion being laterally tapered so that a width thereof decreases from the first width to the second width. The waveguide structure allows an integrated optical device designer satisfying optical circuits needs and, at the same time, ensuring a satisfactory coupling efficiency with an external field.

The present invention generally relates to planar integrated optical waveguides, and, more particularly, to integrated optical waveguides having medium to high refractive index contrast values.

Low refractive index contrast integrated optical waveguides (i.e., waveguides characterized by a refractive index contrast of less than approximately 1%) have traditionally been used in integrated optical devices because, having relatively wide cross-sections, the dimensions of the optical modes supported by these waveguides are comparable to those of standard optical fibers; consequently, high coupling efficiencies are ensured when the integrated waveguides are coupled to optical fibers (fiber-to-waveguide coupling efficiency). In fact, when an optical fiber and an integrated optical waveguide are butt-coupled, the optical power transferred from one optical guiding structure to the other strongly depends on how well the optical modes supported by each of the two optical guiding structures overlap. The overlap integral between the modes supported by the two guiding structures is usually taken as a measure of the coupling efficiency.

In recent years the constant demand of increasing bandwidth for fast data transfer has made it necessary to have low-cost devices of suitable spectral characteristics; to this purpose, the integration scale of integrated optical devices has increased.

High integration scales have been achieved using medium to high refractive index contrast integrated waveguides, which are characterized by refractive index contrast values higher than 1%, up to approximately 40%, depending on the specific application. These integrated waveguides allow fabricating very compact devices, because waveguide patterns with small bending radii, down to few microns, can be formed without incurring in high losses.

Typically, high refractive index contrast integrated waveguides are made of semiconductor materials, such as, for example, InGaAsP/InP and AlGaAs/GaAs. Semiconductor waveguides feature refractive index differences larger than 1×10⁻² (by comparison, in glass optical fibers the refractive index difference is usually less than 5×10⁻³).

However, the use of this kind of waveguides poses problems in terms of losses when the waveguides are coupled to optical fibers. In fact, in order to guarantee single-mode operating conditions in high refractive index contrast waveguides, the waveguides must have rather small cross sections, which implies small optical field dimensions. The dimensions ratio between the mode in the waveguide and that in a fiber coupled thereto can be very low, and the overlap integral between the modes supported by the two guiding structures drops to very low values.

In order to enable the exploitation of high contrast waveguides in many interesting commercial applications, the fiber-to-waveguide coupling losses need to be reduced to acceptable values.

Several solutions to increase the fiber-to-waveguide coupling efficiency in semiconductor waveguides have been reported in the literature.

In particular, several spot-size conversion structures have been proposed for adapting (“converting”) the spot size in the waveguide to that in the fiber. Most of these structures implement combined multilayer laterally and vertically tapered waveguide structures, designed to convert the waveguide field shape into the fiber mode. Examples of these structures are provided in U.S. Pat. No. 6,240,233, describing an integrated optical beam spread transformer for a InGaAsP/InP waveguide, in the technical manuscript “Design and Fabrication of Monolithic Optical Spot Size Transformer (MOST's) for Highly Efficient Fiber-Chip. Coupling” by G. Wenger et al, published in the IEEE Journal Of Lightwave Technology, Vol. 12, No. 10, October 1994, pages 1782 to 1790, describing an optical spot size transformer for InGaAsP/InP waveguides, and in the U.S. Pat. No. 6,229,947 describing a tapered rib waveguide-to-fiber coupler for AlGaAs/GaAs waveguides. A good review of mode-size converters, for semiconductor waveguides is provided in the technical manuscript “A Review on Fabrication Technologies for the Monolithic Integration of Tapers with III-V Semiconductor Devices” by I. Moerman et al, published in the IEEE Journal Of Selected Topics In Quantum Electronics, Vol. 3, No. 6, December 1997, pages 1308 to 1320.

These known mode-size conversion structures are difficult to integrate, and require many fabrication steps in addition to those normally required for fabricating the integrated optical devices and the waveguides. In particular, the two-dimensional (i.e., vertical and lateral) tapering of the above-reported spot-size converter structures significantly complicates the manufacturing process.

An emerging and promising technology for fabricating integrated optical waveguides with low to high refractive index contrast values relies on the use of silicon oxynitride (SiON). Recently, SiON has been increasingly applied in various integrated optical devices; the use of this material has been mainly motivated by its excellent optical properties, such as low absorption losses in the visible and near-infrared wavelength range. Moreover, the refractive index of SiON can be easily adjusted over a large range, between 1.45 (the refractive index of SiO₂) and 2.0 (the refractive index of Si₃N₄). This means that planar integrated waveguides with index contrast ranging from relatively low to very high values can be achieved, meeting the growing demand for high integration density optical components.

Complicated vertically and laterally tapered structures, similar to those proposed for semiconductor waveguides, have also been proposed for high refractive index contrast SiON waveguides; by way of example, the technical paper “A Spot-Size Transformer for Fiber-Chip Coupling in Sensor Application at 633 nm in Silicon Oxynitride”, by R. M. de Ridder et al, published in the Proceedings LEOS '95, Vol. 2, 1995, pages 86 to 87 describes the design of a mode-size adapter for a SiON on SiO₂ waveguide having an index contrast equal to 0.24 (in percentage approximately 16%), consisting of a laterally tapered SiON waveguide having a step-wise decrease in thickness towards the taper point, which may have up to 0.5 μm residual width.

Also in this case, the vertical and lateral tapering makes the manufacturing process complicated.

In order to simplify the manufacturing process, planar spot-size converter structures are required.

Planar spot size converters using periodic, quasi-periodic or non-periodic segmented waveguides have been proposed, as reported for example in the technical paper “A Very Short Planar Silica Spot-Size Converter Using a Nonperiodic Segmented Waveguide” by M. M. Spuehler et al, published in the IEEE Journal Of Lightwave Technology, Vol. 16, No. 9, September 1998, pages 1680 to 1685, which describes a planar spot-size converter structure designed and implemented in a SiO₂/SiON system of materials.

The Applicant observes that these structures can only be designed using sophisticated evolutionary optimization procedures, and require an extremely accurate technology.

Alternative techniques for coupling integrated waveguides to optical fibers reported in the literature make use of lenses or tapered optical fibers. For example, the technical paper “Very low-loss passive fiber-to-chip coupling with tapered fibers” by T. Paatzsch et al, published in Applied Optics, Vol. 36, No. 21, 20 Jul. 1997, pages 5129 to 5133, describes a tapered fiber-to-chip coupling based on the use of fiber tapers embedded in a guiding structure. on the optical circuit, and at least one among a value of the second width and a value of the height of the waveguide core layer is chosen in such a way as to achieve a prescribed efficiency in the coupling of an external optical field having first field dimensions to the integrated waveguide.

According to a third aspect of the present invention, a process for manufacturing an integrated optical waveguide structure is provided, comprising:

forming a lower cladding layer over a substrate;

forming a waveguide core on the lower cladding layer, wherein said forming the waveguide core comprises:

forming a waveguide core layer substantially coextensive to the lower cladding layer and having substantially uniform thickness, and

forming a waveguide core rib, protruding from a surface of the waveguide core layer opposite to a surface thereof facing the lower cladding layer, said waveguide core rib, having a substantially uniform height, the waveguide core rib having a layout defining a path for the guided optical field.

Said forming the waveguide core rib further comprises:

forming at least one coupling waveguide portion designed for coupling an external optical field to a circuit waveguide portion in which the waveguide core rib has a first width. Said forming the at least one coupling waveguide portion comprises in turn:

forming a terminal waveguide core rib portion having a second width lower than the first width and terminating

The Applicant observes that these solutions are hardly practicable in industrial applications.

Simpler planar spot-size converters consist in a waveguide that is only laterally tapered, having a lateral width that varies along a transition section thereof, possibly according to an optimized profile, towards an optimized value at an interface facet with an optical fiber, so as to maximize the overlap integral in the fiber-to-waveguide coupling. In essence, simple laterally tapered waveguide mode converters are based on the fact that, when the waveguide width is decreased below a given value, the width of the mode supported by the waveguide increases; thus, narrowing the waveguide towards the interface facet until a waveguide mode dimension comparable to the fiber mode dimension is attained allows achieving a high fiber-to-waveguide coupling efficiency, while preserving single-mode operation.

It has been shown that these structures can enable high fiber-to-chip coupling efficiencies for InP/InGaAsP buried waveguides. For example, in the technical manuscript “A Simple Laterally Tapered Waveguide for Low-Loss Coupling to Single-Mode Fibers” by K. Kasaya et al, published in the IEEE Photonic Technology Letters, Vol. 5, No. 3, March 1993, pages 345 to 347, a low-loss coupling is reported to have been achieved using a simple InP/InGaAsP tapered waveguide, composed of a laterally tapered InGaAsP guiding layer and an InP cladding region on an InP substrate. The technical manuscript “Design of a Single-Mode Tapered Waveguide for Low-Loss Chip-to-Fiber Coupling” by O. Mitomi et al, published in the IEEE Journal of Quantum Electronics, Vol. 30, No. 8, August 1994, pages 1787 to 1793 describes a procedure for designing nonlinearly tapered InP/InGaAsP waveguides.

Similar results have been obtained for SiON buried waveguides, as reported in the technical manuscript “Design, Tolerance Analysis, and Fabrication of Silicon Oxynitride Based Planar Optical Waveguides for Communication Devices” by K. Woerhoff et al, published in the IEEE Journal of Lightwave Technology, Vol. 17, No. 8, August 1999, pages 1401 to 1407.

In the UK Patent Application No. GB 2 345 980 A, the benefits of a rib integrated waveguide structure are described, and a mode-shape converter having upper and lower optical rib waveguides is described including a substrate, a lower cladding coated over the substrate, a lower rib waveguide, a core, an upper rib waveguide and an upper cladding. The lower rib waveguide defines a stepped pattern existing partially only in a coupling region and in a conversion region.

In semiconductor-based integrated optical device technologies, tapered waveguides have been employed in combination with other structures, as for example described in the European patent application No. EP 1 245 971 A2, describing the provision of lateral rib confinement waveguides extending laterally to a tapered rib waveguide.

Tapered waveguides have also been exploited in applications different from the realization of fiber-to-integrated waveguide coupling structures; for example, the International patent application No. WO 02/42808 A2 describes the use of a tapered waveguide for forming an optical waveguide multimode-to-single mode transformer, for interfacing a laser, having a multi-mode output, to a single-mode optical fiber. The mode transformer has a high refractive index core layer, e.g. made of SiON, surrounded by a lower refractive index cladding. The core layer includes a wide input waveguide section to accept a multimode, including a fundamental mode, light input. The input waveguide section is coupled to a narrow output waveguide section by a tapered region having taper length enabling adiabatic transfer of the fundamental mode of the multimode light from the wide input waveguide section to the output waveguide section while suppressing (stripping) other modes. The narrow output waveguide section supports a single mode light output comprising the fundamental mode. The input waveguide section and the tapered region comprises a ridge waveguide, having a ridge on the core layer, with a width of the ridge decreasing in the tapered region. In the output waveguide section, terminating in an end facet, the lateral margins of the silicon nitride core are etched through to form a real index guided structure.

The Applicant observes that, generally speaking, when an integrated optical component is designed, the integrated waveguide characteristics have to fulfill several requirements: for example, the waveguide geometric dimensions typically have to guarantee a monomodal operation, the refractive index contrast has to be chosen so as to minimize radiation losses in bends and allow high integration density, the material birefringence must be compensated by means of form birefringence or in other ways. In addition, when dealing with high refractive index contrast waveguides, suitable solutions to the problem of fiber-to-waveguide coupling losses need to be devised, so as to keep the losses at an acceptably low level. All these requirements are to be fulfilled with an eye at the fabrication process.

The tapered waveguide mode adapters known in the art are either too complicated to be manufactured, or the design thereof is difficult to be optimized, or, in the case of the simple laterally tapered buried waveguides, only the fiber-to-chip coupling efficiency is optimized (i.e., attention is mainly paid to the width of the tip of the buried waveguide and to the shape of the transition region), without taking in the due consideration the other circuital requirements that need to be satisfied.

In view of the state of the art outlined in the foregoing, it has been an object of the present invention to provide an integrated waveguide structure with a simple, planar mode-size converter for coupling the integrated waveguide to an optical fiber, more generally to an external optical field.

In particular, looking at the state of the art, the Applicant has observed that ridge or rib integrated waveguides are to be preferred over other integrated waveguide structures, such as buried waveguides, because they offer to the designer of integrated optical devices a higher flexibility. Using rib waveguides, it is easier to design integrated waveguides that are optimized both from the viewpoint of the coupling efficiency with an external optical field, for example for coupling the integrated optical device with optical fibers, and from the viewpoint of the other waveguide circuital requirements.

In greater detail, the Applicant has realized that, when dealing with medium to high refractive index contrast structures, i.e., structures with refractive index contrast values ranging from approximately 1% to approximately 40% and, preferably, from approximately 1% to approximately 20%, rib waveguides are preferable to other integrated waveguide structures for the reason that the presence of the slab offers a further degree of freedom to the designer, and a favorable tradeoff between the different requirements is more easily reached. For instance, the slab height can be exploited to enable the material birefringence compensation in favor of polarization-insensitive operation. Moreover, a thick slab allows high coupling coefficients and wider gaps in directional couplers in favor of higher tolerance to the technological process; on the other hand, an excessive slab height causes high radiation losses in small radii bends of the waveguides; the slab thickness also influences the coupling efficiency with optical fibers and the single mode operation. The different physical and geometrical parameters (refractive index contrast, waveguide dimensions, slab height) can be used to meet a set of different requirements: integration density, bending radiation losses, single mode condition, mode dimensions and so on.

According to a first aspect of the present invention, there is provided an integrated optical waveguide structure as set forth in claim 1.

Summarizing, the integrated waveguide structure comprises a waveguide core for guiding an optical field, the waveguide core being formed on a lower cladding layer; the waveguide core comprises a waveguide core layer substantially coextensive to the lower cladding layer and having a substantially uniform thickness, and a waveguide core rib, of substantially uniform height, protruding from a surface of the waveguide core layer opposite to a surface thereof facing the lower cladding layer, a layout of the waveguide core rib defining a path for the guided optical field.

For the purposes of the present invention, substantially coextensive means that the waveguide core layer has a surface extension sufficiently wide so that the optical field in the waveguide core layer is substantially equal to zero proximate to the borders of the waveguide core layer. For example, the waveguide core layer has a size of at least two times the maximum width at 1/e of the local optical field. In other words, the surface extension of the waveguide core layer is such as not to substantially affect the lateral confinement of the light, the light lateral confinement being instead provided only by the waveguide core rib.

The integrated optical waveguide structure comprises a circuit waveguide portion in which the waveguide core layer has a first width, adapted to guiding the optical field through an optical circuit, and at least one coupling waveguide portion adapted to coupling the circuit waveguide portion to an external optical field.

The coupling portion comprises a terminal waveguide core rib portion having a second width lower than the first width and terminating in a facet, and a transition waveguide core rib portion optically joining to each other the waveguide core rib of the circuit waveguide portion and the terminal waveguide core rib portion. The transition waveguide core rib portion is laterally-tapered so that a width thereof decreases from the first width to the second width.

In a preferred embodiment of the invention, a ratio between the second width and the first width, and a ratio between the height of the waveguide core layer and an overall height of the waveguide core are chosen in such a way as to keep coupling losses arising when the external optical field is coupled to the integrated waveguide below a prescribed level.

In particular, at least one among a value of the first width, a value of the overall height of the waveguide core and a value of the height of the waveguide core layer is chosen in such a way as to comply with requirements on the circuit waveguide portion depending on the optical circuit; at least one among a value of the second width and a value of the height of the waveguide core layer is instead chosen in such a way as to achieve a prescribed efficiency in the coupling of the integrated waveguide to an external optical field having first field dimensions.

The circuit waveguide portion may be designed to support an optical field of second field dimensions equal to or lower than the first field dimensions; the coupling waveguide portion performs a field dimensions adaptation for adapting the second field dimensions to the first field dimensions.

In an embodiment of the invention, the circuit waveguide portion is designed in such a way as to support a single-mode optical field. However, this is not strictly necessary, because single-mode excitation in the circuit waveguide portion is ensured by the limited width of the terminal waveguide core rib portion.

Preferably, the integrated circuit waveguide is designed in such a way that a ration of the first field dimensions to the second field dimensions falls in the range from approximately 1 to approximately 3.

The lower cladding layer has a first refractive index, the waveguide core has a second refractive index and an upper cladding covering the waveguide core has a third refractive index; in a preferred embodiment of the invention the first, second, and third refractive indexes are such that a refractive index contrast between the waveguide core and the lower and upper claddings falls in the range from approximately 1% to approximately 20%, more preferably in the range from approximately 5% to approximately 7%.

Advantageously, the waveguide core is made of silicon oxynitride (SiON); the lower cladding layer is made of silicon dioxide; the upper cladding may be made of silicon dioxide or gas, e.g. air.

In a preferred embodiment of the present invention, a length of the transition waveguide core rib portion is chosen in dependence of a ratio between the first width and the second width. In particular, such a length is chosen to be at least equal to a minimum length that, expressed in microns, is given by the formula (1−W/W₀)*500.

The terminal waveguide core rib portion preferably has a length chosen to be the shortest possible length taking account of technological tolerances in a process of separating a die in which the optical waveguide structure is integrated from other dies formed from a same wafer. In particular, the length of the terminal waveguide core rib portion may be determined on the basis of said minimum length and of the length of the transition waveguide core rib portion. Preferably, the length of the terminal waveguide core rib portion is chosen to be approximately equal to a value that, expressed in microns, is given by the formula L_{tec}exp(−(L/Lₘᵢₙ)²), where L_{tec} denotes a length depending on said technological tolerances and Lₘᵢₙ is said minimum length.

According to a second aspect of the present invention, there is provided a method as set forth in claim 16 of coupling an external optical field to an integrated optical waveguide of a type comprising a waveguide core for guiding an optical field, formed on a lower cladding layer, wherein the waveguide core comprises a waveguide core layer substantially coextensive to the lower cladding layer and having a substantially uniform thickness, and a waveguide core rib, of a substantially uniform height, protruding from a surface of the waveguide core layer opposite to a surface thereof facing the lower cladding layer, a layout of the waveguide core rib defining a path for the guided optical field.

The coupling method comprises providing at least one coupling waveguide portion, designed for coupling an external optical field to a circuit waveguide portion in which the waveguide core rib has a first width.

The coupling waveguide portion comprises a terminal waveguide core rib portion having a second width lower than the first width and terminating in a facet, and a transition waveguide core rib portion optically joining to each other the waveguide core rib in the circuit waveguide portion and the terminal waveguide core rib portion. The transition waveguide core rib portion being laterally-tapered so that a respective width decreases from the first width to the second width.

In an embodiment of the invention, a ratio between the second width and the first width, and a ratio between the height of the waveguide core layer and an overall height of the waveguide core are chosen in such a way as to keep coupling losses arising when the external optical field is coupled to the integrated waveguide below a prescribed level.

In particular, at least one among a value of the first width, a value of the overall height of the waveguide core and a value of the height of the waveguide core layer may be chosen in such a way as to comply with requirements on the circuit waveguide portion depending in a facet, and

forming a transition waveguide core rib portion optically joining to each other the waveguide core rib in the circuit waveguide portion and the terminal waveguide core rib portion, said transition waveguide core rib portion being laterally-tapered so that a respective width decreases from the first width to the second width.

In an embodiment of the present invention, said forming the waveguide core comprises:

forming a material layer over the lower cladding layer, and

selectively, removing the material layer to define the waveguide core layer and the waveguide core rib.

Expediently, the terminal portion and the transition portion are formed simultaneously with said forming of the waveguide core rib.

The features and advantages of the present invention will be made apparent by the following detailed description of an exemplary embodiment thereof, description that will be conducted making reference to the annexed drawings, wherein:.

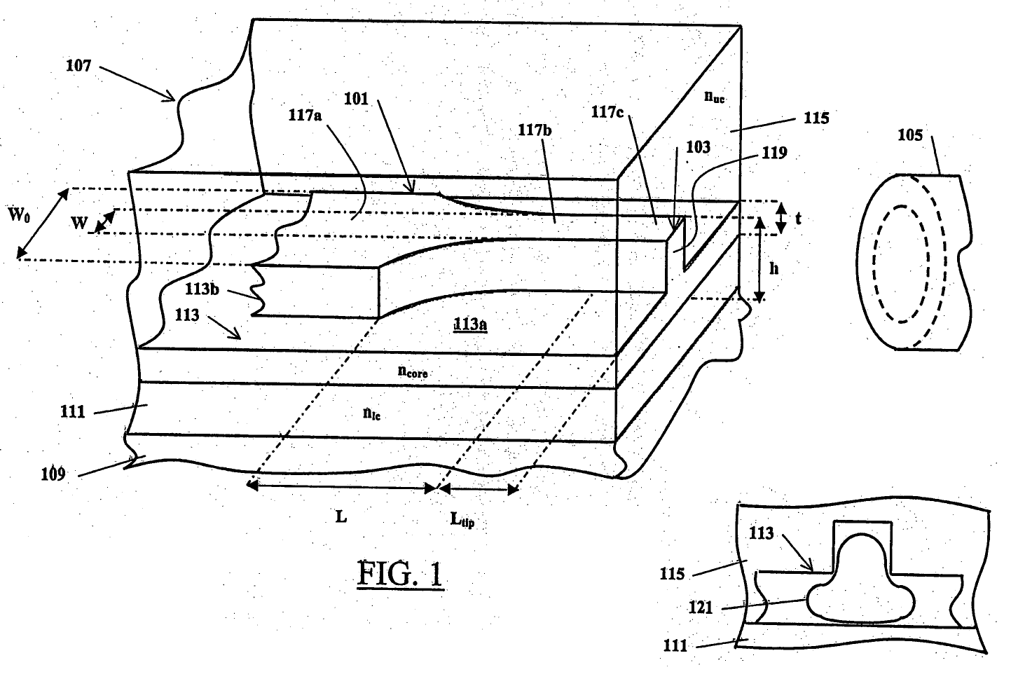

FIG. 1 is a schematic illustration of a planar integrated optical waveguide according to an embodiment of the present invention;

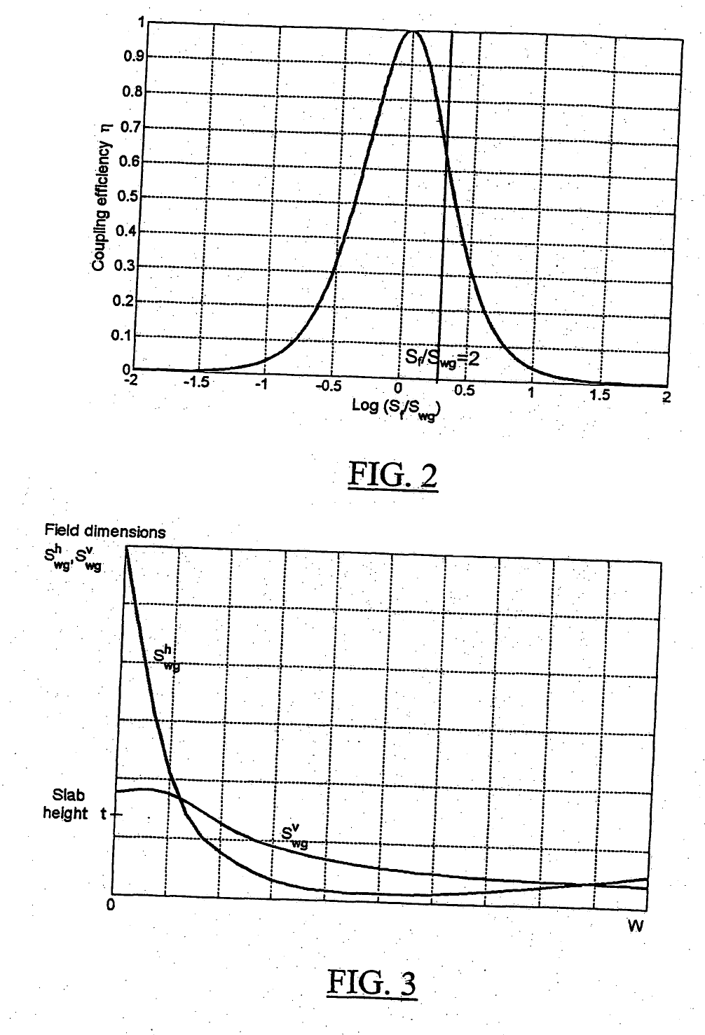

FIG. 2 is a diagram showing the variation of the coupling efficiency between two circular gaussian optical fields (in ordinate), one in an optical fiber and the other in an integrated optical waveguide, as a function of the ratio of the field diameters at 1/e (in abscissa, logarithmic scale);

FIG. 3 is a diagram showing the width and height at 1/e (in ordinate) of an optical mode supported by the waveguide of FIG. 1, as a function of a width of the waveguide (in abscissa);

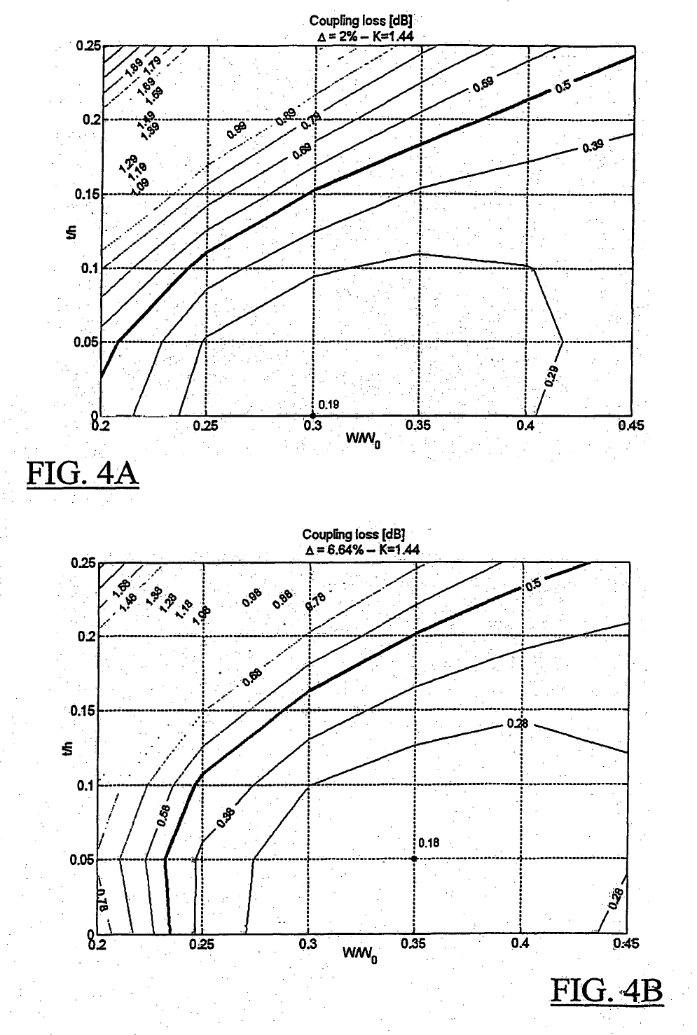

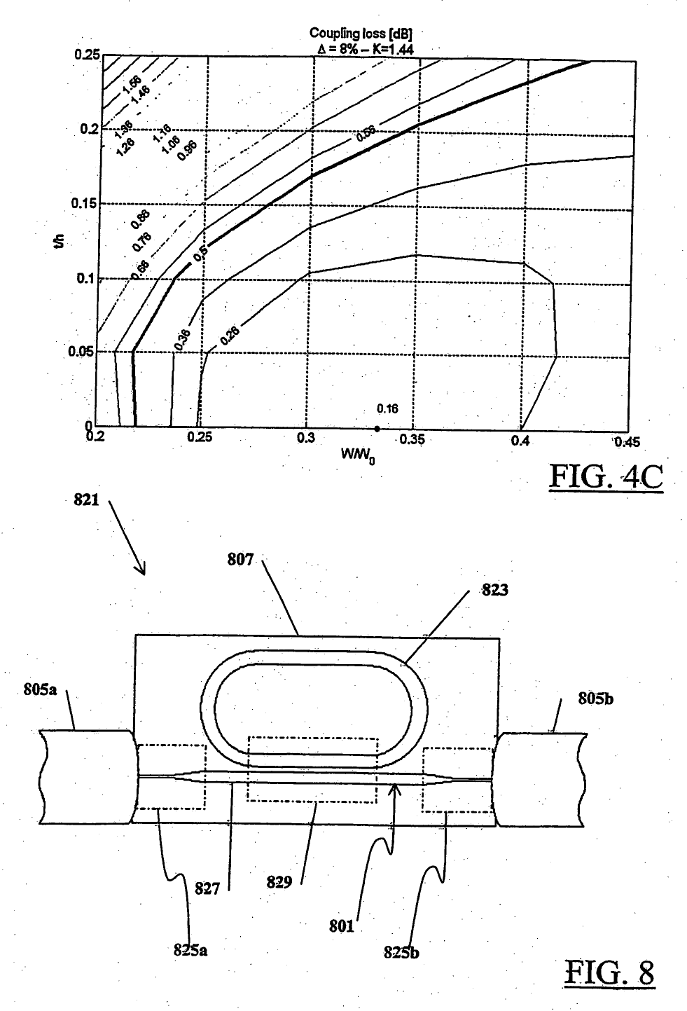

FIGS. 4A, 4B and 4C show contour plots of waveguide-to-fiber coupling losses simulated for the waveguide of FIG. 1 as a function of the ratio of a waveguide core layer height to the overall waveguide core height (t/h, in ordinate) and of the ratio of the width of a waveguide tip to a width of a waveguide circuit portion (W/W₀, in abscissa) of a waveguide according to an embodiment of the present invention, for three different values of refractive index contrast and for a fixed ratio of fiber-to-waveguide mode dimensions;

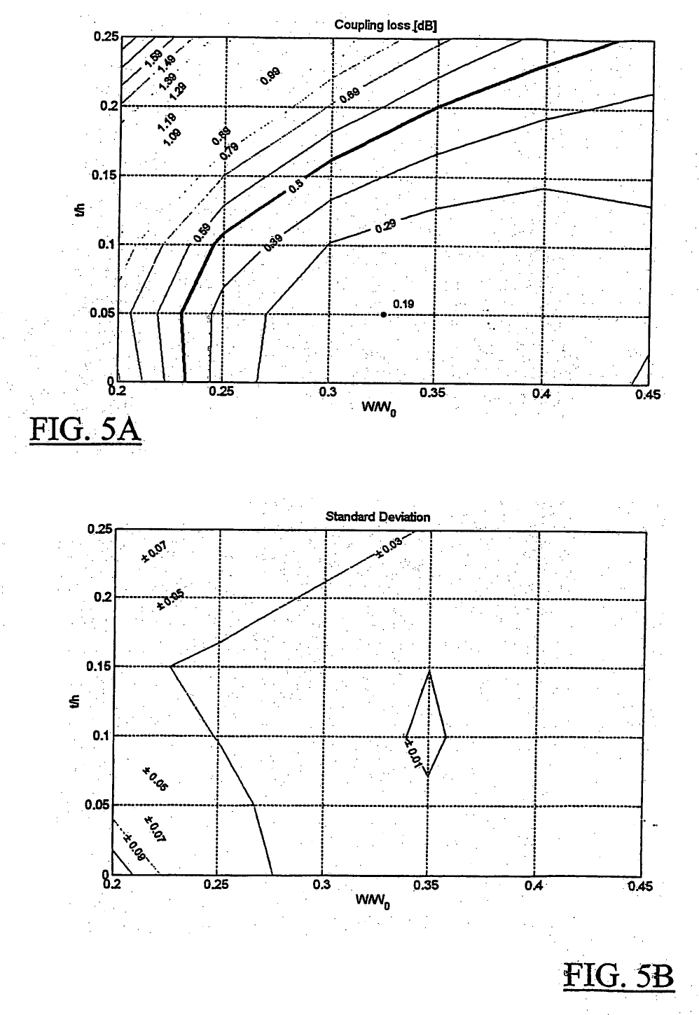

FIG. 5A is a diagram similar to those of FIGS. 4A, 4B and 4C, showing contour plots of average coupling losses calculated from the coupling losses values depicted in the diagrams of FIGS. 4A, 4B and 4C;

FIG. 5B is a diagram similar to those of FIGS. 4A, 4B and 4C showing the standard deviations of the coupling losses from the average coupling losses reported in FIG. 5A.

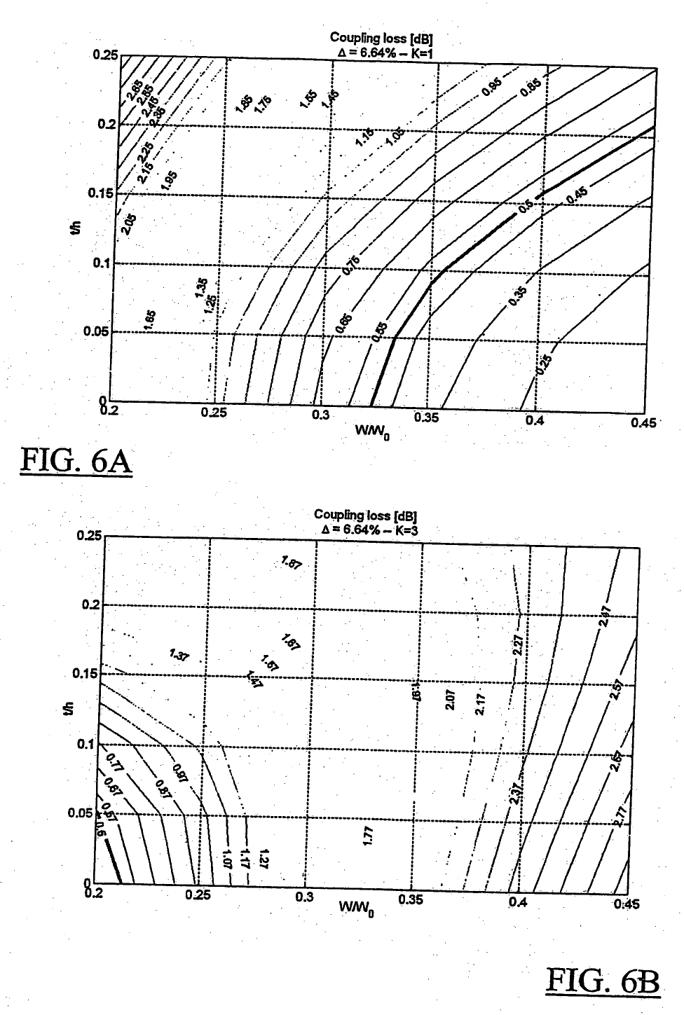

FIGS. 6A to 6C show coupling losses contour plots diagrams similar to those of FIGS. 4A, 4B and 4C, simulated for the waveguide of FIG. 1 for two different values of the ratio of fiber-to-waveguide mode dimensions, and for a fixed value of refractive index contrast, equal to that corresponding to the diagram of FIG. 4B;

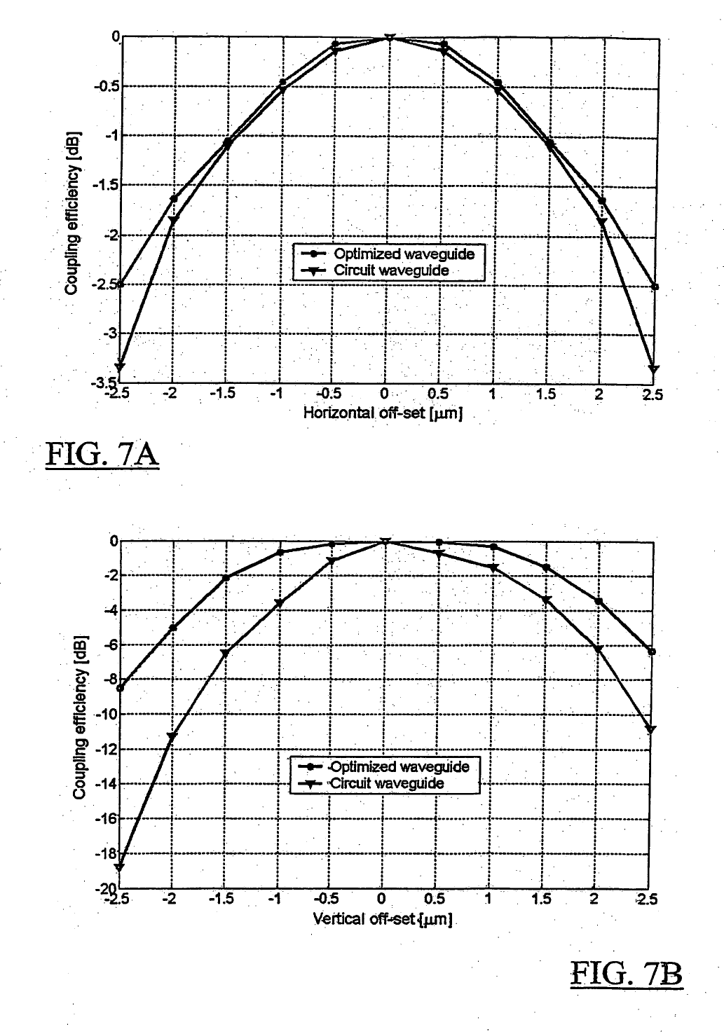

FIGS. 7A and 7B are diagrams showing the measured coupling efficiencies (in ordinate, dB scale) as a function of the fiber-to-waveguide misalignment along the horizontal axis and, respectively, the vertical axis (in abscissa, μm); and

FIG. 8 schematically depicts an exemplary integrated optical device, in which a waveguide structure according to an embodiment of the present invention is exploited.

Throughout the different drawings, identical reference numerals are used to identify identical or corresponding parts. Furthermore, it is pointed out that the drawings are not necessarily in scale, emphasis being instead placed upon clearly illustrating the principles of the invention.

Referring to FIG. 1, a planar integrated optical waveguide structure according to an embodiment of the present invention is schematically shown. More precisely, only a small portion of a waveguide 101 is depicted in the drawing, namely a waveguide portion proximate to an edge or tip 103 of the waveguide 101, intended to be coupled to, e.g., an optical fiber 105 (more generally, to an external optical field, either guided or not).

The waveguide 101 is integrated in a chip 107 in which one or more optical components (not shown in FIG. 1) can also be integrated. The chip 107 includes a substrate 109, for example a silicon wafer die. Over the substrate 109, a lower cladding layer 111 is formed; the lower cladding layer has a refractive index n_{1c}; for example, the lower cladding layer is made of SiO₂ (n_{1c}=1.45), is formed by Chemical Vapor Deposition (CVD), particularly Plasma-Enhanced CVD (PECVD), and has a thickness of some microns.

On the lower cladding layer 111, a waveguide core 113 is formed, having a refractive index n_{core}. The waveguide core 113, made for example of silicon oxynitride (SiON), having a refractive index n_{core} that falls in the range from approximately 1.45 to approximately 2, is formed by depositing a SiON layer on the lower cladding layer 111, e.g. by CVD and, particularly, PECVD. Then, by means of conventional photolithographic techniques followed by an etching step, e.g., by Reactive Ion Etching (RIE), the deposited SiON layer is patterned, so as to form a core base layer (in jargon, a slab) 113a, of substantially uniform height t throughout the die, and, on the core base layer 113a, a core ridge or rib 113b, of height (h−t), where h denotes the overall height of the waveguide core 113.

If desired or necessary, a birefringence compensating layer (not shown in the drawing) can be formed, interposed between the lower cladding layer 111 and the waveguide core 113; for example, the birefringence compensating layer may be made of silicon nitride (Si₃N₄), formed by Low-Pressure CVD (LPCVD).

An upper cladding 115 of refractive index n_{uc} covers the waveguide core 113. The upper cladding 115 can be a material layer, for example made of SiO₂, similarly to the lower cladding layer 111 (in which case the upper cladding refractive index n_{uc} and the lower cladding refractive index n_{1c} coincide). Alternatively, the upper cladding 115 can be made of, e.g., air (refractive index n_{uc} equal to 1), or other fluid or gas.

As depicted in the detail of FIG. 1, an optical field 121 propagates through the waveguide 101 being guided by and being substantially confined within the waveguide core 113. In particular, the waveguide core rib 113b confines the optical field 121 upperly and laterally, and the layout pattern thereof determines the optical field path in a plane parallel to that of the core base layer 113a.

The waveguide core rib 113b has a substantially uniform height (h−t) throughout the die. The waveguide core rib 113b has instead a variable width in different regions of the chip 107. In particular, the waveguide core rib 113b has a circuit waveguide core rib portion 117a, of prevailing length, which is the portion of the waveguide intended to interact with the optical device or devices integrated in the chip 107; the circuit waveguide core rib portion 117a has a first width (circuit waveguide width) W₀. Proximate to the waveguide tip 103, a laterally-tapered, transition waveguide core rib portion 117b, of length L and variable width, joins the circuit waveguide portion 117a to a tip waveguide core rib portion 117c, of length Lₜᵢₚ and having a second width (tip waveguide width) W lower than the circuit waveguide width W₀. Opposite to the transition portion 117b, the tip waveguide core rib portion 117c terminates in a facet 119 (typically, but not limitatively, a facet coincident with the chip perimetral boundary; more generally, a interface facet between a region of the space in which the layer 113 is present, and an adjacent region of space in which the layer 113 is absent, for example in correspondence of a groove formed in an area of the chip), through which the waveguide 101 can be interfaced to an external optical field, e.g. carried by the optical fiber 105, or can emit optical radiation.

The reduction in width of the waveguide core rib 113b in proximity of the waveguide tip 103 creates a mode spot-size converting structure, that widens the optical mode supported by the waveguide to dimensions comparable to the external field dimensions, particularly to dimensions comparable to those of the optical mode supported by the optical fiber. In the circuit waveguide core rib portion 117a, the waveguide core rib can have a larger width; by way of example, in an embodiment of the present invention, the width in the circuit waveguide core rib portion 117a can be the maximum width that still guarantees the single-mode operating condition.

In the integrated optical waveguide 101, the circuit waveguide portion has a strong guiding action, at least for the fundamental optical mode, while the tip waveguide, having a reduced core rib width, has a weak guiding action on the fundamental mode.

The profile and the length L of the laterally-tapered transition waveguide core rib portion 117b are chosen to avoid abrupt transitions between the narrower tip waveguide core rib portion 117c and the wider circuit waveguide core rib portion 117a.

In particular, the length L and the profile of the laterally-tapered transition waveguide core rib portion 117b may be determined according to any known design procedure, for example the one described in the already cited technical manuscript “Design of a Single-Mode Tapered Waveguide for Low-Loss Chip-to-Fiber Coupling” by O. Mitomi et al, published in the IEEE Journal of Quantum Electronics, Vol. 30, No. 8, August 1994, pages 1787 to 1793, the content of which is incorporated herein by reference.

The planar integrated waveguide structure depicted in FIG. 1 offers to the integrated optical device designer a great flexibility in the task of designing an integrated waveguide that satisfies the requirements in terms of both circuit waveguide characteristics and coupling efficiency with, e.g., an optical fiber. In particular, while one or more of the overall height h of the waveguide core 113, the height t of the slab 113a and the width W₀ of the circuit waveguide core rib portion 117a can be chosen in such a way as to satisfy circuit requirements for the waveguide, i.e., requirements deriving from the interaction of the waveguide with the optical devices integrated in the chip 107, the designer is left free to determine at least one among the height t of the slab 113a and the tip waveguide width W in such a way as to optimize the coupling efficiency between the waveguide and a selected optical fiber, having a given mean mode diameter.

In other words, the adoption of a rib waveguide structure, i.e., a waveguide structure in which the waveguide core comprises a core base layer, or slab, 113a, of uniform thickness, and core rib 113b, offers the possibility of designing and fabricating waveguides that are optimized in respect to the circuit requirements, and, by means of simple, laterally-tapered mode spot-size conversion structures, are also optimized in respect of the coupling efficiency with external fields.

In the following, a procedure according to an embodiment of the present invention for dimensioning the integrated waveguide structure schematically shown in FIG. 1 will be described.

First of all, in order to evaluate the coupling efficiency η between the integrated waveguide and an external optical field, e.g. an optical field guided by the optical fiber 105, an overlap integral between the modes supported by the two guiding structures is defined as follows:

$$η = \frac{{[ \int {e}_{f} ( x , y ) {e}_{wg} ( x , y ) d x d y ]}^{2}}{\int {e}_{f}^{2} ( x , y ) d x d y \int {e}_{wg}^{2} ( x , y ) d x d y} ,$$

where e_{f}(x,y) and e_{wg}(x,y) denote the transverse field distributions in the optical fiber and in the integrated waveguide, respectively. In the case that two circular gaussian distributions with field width at 1/e equal to S_{f} and S_{wg} are considered, the coupling efficiency η assumes the simpler expression:

$$η = {( \frac{2 {S}_{wg} {S}_{f}}{{S}_{wg}^{2} + {S}_{f}^{2}} )}^{2} .$$

In FIG. 2, a diagram of the coupling efficiency η (in ordinate) as a function of the ratio S_{f}/S_{wg} (in abscissa, logarithmic scale) is shown.

The integrated waveguide 101 has a refractive index contrast Δ defined as:

$$Δ = \frac{2 {n}_{core} - {n}_{lc} - {n}_{uc}}{{n}_{lc} + {n}_{wc}} .$$

The refractive index contrast Δ depends on the refractive indexes n_{core}, n_{1c} and n_{uc}; in the exemplary case that the lower cladding and the upper cladding are made of SiO₂, a SiON waveguide core of refractive index equal to 1.4645 corresponds to a refractive index contrast Δ of approximately 1%, while a SiON waveguide core of refractive index equal to 2 corresponds to a refractive index contrast Δ of approximately 40%,

In general, a rib waveguide having a rib of width W₀, an height h and a slab height t, supports a mode with a vertical dimension S^{v}_{wg} at 1/e, a horizontal dimension S^{h}_{wg} at 1/e, and an average mode size S_{wg} equal to:

S_{wg}=(S^{v}_{wg}+S^{h}_{wg})/2.

Let it also be assumed that the mean spot size at 1/e S_{f} of the optical fiber to which the waveguide has to be coupled is:

S_{f}=K·S_{wg}

where K=S_{f}/S_{wg} is the ratio of the fields dimensions, and it is K≧1.

From the diagram of FIG. 2 it can be appreciated that when the fields dimensions ratio K departs from unity, the coupling efficiency rapidly drops to quite low values. For example, when a standard single mode optical fiber with mean spot size S_{f} of approximately 10 μm is coupled to a waveguide with index contrast Δ approximately equal to 2%, having an average mode size S_{wg} of approximately 4.6 μm, the resulting fields dimensions ratio K is approximately equal to 2.17, and a coupling efficiency of about 58% is achieved; when a waveguide with an index contrast Δ of approximately 6% is considered, having an average mode size S_{wg} of approximately 2.8 μm, the resulting fields dimensions ratio K is approximately equal to 3.17, and the coupling efficiency falls to 27%. A drastic drop of the coupling efficiency to 18% results from a waveguide with an index contrast Δ of approximately 8%, having an average mode size S_{wg} of 2.2 μm (fields dimensions ratio K of approximately 4.54).

By using the waveguide structure of FIG. 1, it is possible to maximize the coupling efficiency and, at the same time, decrease the fiber-to-waveguide alignment sensitivity. This can be achieved by properly varying the values of the parameters L, W, Lₜᵢₚ, h and t. In particular, the coupling efficiency between the modes in the optical fiber and in the waveguide can be maximized by properly choosing the values for the width W of the waveguide tip and the height t of the slab 113a.

In FIG. 3, a diagram showing the variation of the field vertical dimension S^{v}_{wg} and the field horizontal dimension S^{h}_{wg} (both in ordinate) at the interface facet 119 with the waveguide tip width W is presented. It can be appreciated that both the vertical dimension S^{v}_{wg} and the horizontal dimension S^{h}_{wg} of the field vary with the waveguide tip width W; in particular, by decreasing the width W, the field horizontal dimension S^{h}_{wg} increases accordingly, tending to infinity as the width W tends to zero; on the contrary, the field vertical dimension S^{v}_{wg} increases up to a value substantially equal to the vertical dimension of the field in the slab 113a, and, if the waveguide is symmetrical, cannot be increased any further. In the case of an asymmetrical waveguide structure and a slab height t underneath cut-off is considered, also the field vertical dimension S^{v}_{wg} tends to infinity when the width W tends to zero.

The Applicant has carried out numerical investigations on the waveguide structure of FIG. 1 in order to establish the values of the waveguide parameters that maximize the coupling efficiency with the optical fiber mode, and the results of these investigations are reported hereinbelow.

Referring to FIGS. 4A, 4B and 4C, diagrams showing contour plots of the coupling losses (defined as the one-complement 1−η of the coupling efficiency μ), in dB, as a function of the two waveguide geometrical parameter ratios W/W₀ (in abscissa) and t/h (in ordinate) are depicted. The diagrams have been obtained by calculating the overlap integral between the optical field in the waveguide at the interface facet 119, simulated by a simulator based on the beam propagation method, and the circular gaussian field of an optical fiber. It is pointed out that the diagrams of FIGS. 4A, 4B and 4C have been obtained simulating the propagaticn of the optical field only in the tip of the waveguide 101 (corresponding to the tip waveguide core rib portion 117c). More precise numerical results can be obtained simulating the propagation of the field through the whole waveguide 101, including the transition portion 117b (once a specific profile thereof is chosen) and the circuit portion 117a. However, the Applicant observes that the resulting diagrams would differ only slightly from a numerical viewpoint, and would be substantially identical from a qualitative point of view.

In particular, in the calculations that led to the three diagrams of FIGS. 4A, 4B and 4C, the fields dimensions ratio K has been kept constant and equal to 1.44, while the refractive index contrast Δ has been varied: Δ=2% for the diagram of FIG. 4A, Δ=6.64% for that of FIG. 4B and Δ=8% for the diagram of FIG. 4C, so as to establish the dependence of the coupling efficiency of the structure from the index contrast Δ.

It can be appreciated that optimum values for the ratios W/W₀ and t/h can be determined, which depend on the refractive index contrast, that guarantee minimum coupling losses, and thus maximum coupling efficiency. For example, considering the diagram of FIG. 4B, a minimum of coupling losses of 0.18 dB can be achieved if W/W₀=0.35 and t/h=0.05. It is important to note that choosing as a working point the point corresponding to the minimum coupling losses ensures minimum sensitivity of the system to the variations of geometrical and optical parameters, so that the tolerances on these parameters have a weak influence on the resulting coupling efficiency of the structure.

Additionally, it can be appreciated that if, in order to satisfy contingent needs, one or both of ratios W/W₀ and t/h cannot be chosen equal to the optimum, for example, for satisfying particular circuit requirements, the designer need to use a slab height t such that, in combination with a given waveguide height h, the ratio t/h is different from the optimum value, the coupling losses can still be kept below desired levels by choosing values of the parameters W, W₀, t, and h such that the ratios W/W₀ and t/h are within prescribed ranges, which depends on the refractive index contrast. For example, considering again the diagram of FIG. 4B, as long as the geometrical parameters W, W₀, t and h are chosen in a way such that 0.3≦W/W₀≦0.44 and t/h≦0.1, the coupling losses remain below 0.28 dB. The higher the coupling losses that the designer can accept, the wider the ranges within which the ratios W/W₀ and h/t, and thus the parameters W, W₀, t and h, can vary. Thus, in addition to determining an optimum working point, an optimum working area can be determined, which guarantees that the coupling losses remain below a predetermined level.

Another important aspect that can be appreciated looking at the diagrams of FIGS. 4A, 4B and 4C is that, in order to keep the coupling losses below a predetermined level, the values of the ratios W/W₀ and h/t, not those of the individual geometrical parameters W, W₀, t and h, need to fall within prescribed ranges; this means that the designer is left free to choose the absolute value of the geometrical parameters W, W₀, t and h of the waveguide according to other requirements, such as monomodality, minimum bending radius, directional couplers efficiencies, and the like.

By comparing the three diagrams of FIGS. 4A, 4B and 4C to each other, it can be appreciated that as the refractive index contrast A varies, the coupling losses and the optimum working point vary slightly; thus, the different values of the ratios W/W₀ and t/h correspond to different coupling losses. The diagram in FIG. 5A reports contour plots of the coupling losses calculated by averaging the results reported in the diagrams of FIGS. 4A, 4B and 4C and, in FIG. 5B, a diagram showing the standard deviations of the coupling losses values in the different regions of the plane (W/W₀; t/h) is shown. It can be appreciated that the structure has a low sensitivity to variations of the refractive index contrast Δ (at least, within the chosen range of variability) for a constant fields dimensions ratio K (equal to 1.44). Thus, once the maximum level of acceptable coupling losses is chosen, for example 0.5 dB, it is possible to determine a working region, in terms of values of the geometrical parameters ratios W/W₀ and h/t, within which the variations in the resulting coupling losses can be kept within a predetermined tolerance as the refractive index contrast vary; for example, such a tolerance can be as low as ±0.01 dB, so that the coupling losses are made substantially independent from the refractive index contrast.

In the diagrams of FIGS. 4A, 4B, and 4C the refractive index contrast Δ varied between 2% and 8%; however, the Applicant has observed that similar results are obtained even in the case the refractive index contrast Δ takes values significantly higher than 8%, for example 20% or even more (theorically, these results can be obtained for any refractive index contrast Δ, provided that the value of K is suitable, as discussed below);

The diagrams in FIGS. 6A and 6B show the contour plots of the coupling losses calculated for values of K=1 and K=3, respectively, and a refractive index contrast Δ of 6.64%, as in the diagram of FIG. 4B. It can be appreciated that, differently from the previous case, the coupling losses contour plots change significantly with the fields dimensions ratio K; in particular, as K increases, the optimum working region moves to smaller values of the ratios W/W₀ and t/h.

The considerations made above allows stating that once the value of the fields dimensions ratio K has been established, the coupling losses as a function of the ratios W/W₀ and t/h vary slightly with changes in the refractive index contrast Δ; in other words, for each value of K, a family of diagrams similar to those of FIGS. 4A, 4B and 4C can be derived for each different values of Δ.

From a practical: viewpoint, provided that a working area in terms of the geometrical parameter ratios W/W₀ and t/h needs to be determined within which coupling losses below 0.5 dB are guaranteed, a value of K substantially equal to 3 appears to be a reasonable upper limit for the values of K. In fact, looking at FIG. 6B, for values of K higher than 3 the area within which the coupling losses are below 0.5 dB tends to reduce itself to a dot at the origin of the plane (W/W₀; t/h). However, it is observed that values of higher than 3 can be considered, provided that coupling losses higher than 0.5 dB can be accepted.

Concerning the laterally-tapered transition waveguide core rib portion 117b, as mentioned in the foregoing it can be designed in a conventional way, so as to avoid abrupt transitions between the narrower tip waveguide core rib portion 117c and the wider circuit waveguide core rib portion 117a. Typically, the length L of the transition waveguide core rib portion 117b is chosen to be of the order of the hundreds of microns.

In a preferred embodiment of the present invention, the length L of the transition waveguide core rib portion 117b is chosen greater than a minimum value Lmin defined as:

Lmin=(1−W/W₀)L₀,

where L₀ is the minimum length of the transition waveguide core rib portion 117b that guarantees an adiabatic transition even in case that the width W of the tip waveguide core rib portion 117c is chosen to be equal to zero and the area of the interface facet 119 reduce to zero, thereby the interface of the waveguide to the external field reduces to the slab 113a only. In the dimensioning of several different spot-size conversion structures, the Applicant has observed that waveguide transition portions shorter than 500 μm are capable of ensuring a good adiabatic transformation of the optical field from the wider circuit waveguide portion to the narrower tip waveguide portion. Adiabatic transitions are not prevented by the use of longer waveguide transition portions, but no additional benefits have been observed that could justify a greater occupation of area. Thus, the Applicant has taken 500 μm as the lower limit L₀ of the length of the transition portion in the most critical case of a width W reduced to zero.

From the dimensioning of several different spot-size conversion structures, and based on values provided in the literature, the Applicant has observed that it can be demonstrated that if the condition L≧Lmin is satisfied, the transition waveguide core rib portion 117b is adiabatic and the diagrams shown in FIGS. 4A, 4B, 4C are guaranteed.

The length Lₜᵢₚ of the tip waveguide core rib portion 117c is chosen to be of the order of the hundreds of microns, and the effective length of this waveguide core is rib portion is determined by taking into account the technological tolerances in cutting the wafer into individual dies and in preparing the chip edge face. Typically, Lₜᵢₚ is chosen to be equal to or greater than 100 μm. Anyway, it is observed that Lₜᵢₚ should be as small as possible, because, in propagating through the tip waveguide core rib portion 117c, due to the small waveguide cross section in that rib portion, the optical field tends to be weakly guided and consequently excessive radiation losses could take place. If the transition waveguide core rib portion 117b is sufficiently long and W/W₀ is near 1, there is no reason for having a long tip waveguide core rib portion 117c to protect the structure from technological tolerances; on the contrary, a suitable guard has to be provided when short transition regions and small W/W₀ values are considered. For these reasons, the following value for the length of the tip waveguide core rib portion 117c is considered:

Lₜᵢₚ=L_{tec}exp[−(L/Lmin)²],

where L_{tec} depends on the technological tolerance in cutting the wafer into dies and in preparing the chip edge face. The Applicant has found that a reasonable value for L_{tec} is 300 μm and this is the maximum value that guarantees negligible propagation losses.

In addition to the advantages already discussed in the foregoing, the integrated waveguide structure of FIG. 1 shows two other important properties.

When the integrated waveguide structure is used as an input port of a component, the input optical fiber is coupled to the tip waveguide core rib portion 117c, which ensures monomodality thanks to the extremely small cross section thereof. This fact guarantees that only the fundamental mode is excited in the circuit waveguide circuit waveguide core rib portion 117a, i.e., in the circuit waveguide, irrespective of any possible misalignment between the fiber and the waveguide. This feature becomes extremely useful when the circuit waveguide is dimensioned to have a cross-sectional area close to, or even above the second guided mode cut-off (case in which a two mode propagation is possible), but only the fundamental mode excitation is desired.

Furthermore, experimental results conducted by the Applicant have shown that the waveguide structure of FIG. 1 enables high coupling efficiencies with large misalignment tolerances. To illustrate this last feature, the Applicant has fabricated a waveguide having the structure shown in FIG. 1 with the following parameter values:

Δ=6.35%;

W₀=2.4 μm;.

h=1.8 μm;

t=0.4 μm;

L=240 μm;

W=0.8 μm;

Lₜᵢₚ=200 μm.

The laterally-tapered transition waveguide core rib portion 117b had a cubic profile, and the integrated waveguide has been coupled to a small-core optical fiber with average mode dimension at 1/e (S_{f}) equal to 3.6 μm.

The circuit waveguide average mode dimension at 1/e. (S_{wg}) was determined to be equal to 2.6 μm; consequently, the value of K was 1.38.

From the choice of the geometrical parameters made, the value of the ratio W/W₀ was 0.33, that of the ratio t/h was 0.22.

Referring to the diagrams of FIGS. 5A and 5B, a coupling loss slightly higher than 0.5 dB is expected.

A coupling loss of 0.53 dB has been measured: this result is considered in very good agreement with the design procedure previously presented, considering that the diagrams in FIGS. 5A and 5B were obtained from simulations considering a slightly different value of K equal to 1.44, and that experimental and technological tolerances have to be taken into account.

For the purpose of comparison, the optical fiber has also been coupled to a second integrated waveguide structure without the mode spot-size conversion structure of FIG. 1, i.e., an integrated waveguide coinciding with the circuit waveguide of FIG. 1. In this case, the measured coupling loss amounted to 0.8 dB.

The diagrams in. FIGS. 7A and 7B report the measured coupling efficiencies (in ordinate, dB scale) as a function of the fiber horizontal (FIG. 7A) and vertical (FIG. 7B) misalignments (in abscissa, μm) in the: two experimental cases discussed above. The curve s have been normalized to their maximum value. It is clear that the waveguide structure of FIG. 1 is less sensitive to the alignment, especially along the vertical axis.

The integrated waveguide structure of FIG. 1 can be employed in the realization of any integrated optical component.

Just to give an example, in FIG. 8 an integrated optical component 821 is schematically shown comprising, integrated in a chip 807, a ring filter 823, particularly, but not at all limitatively, a filter for high bit rate applications operating at a wavelength equal to 1550 nm. The ring filter 823 comprises an integrated waveguide similar to the circuit waveguide portion shown in FIG. 1.

A waveguide 801 is integrated in the chip 807. The waveguide 801 has the structure shown in FIG. 1, and includes an input mode spot-size converter 825a, an output mode spot-size converter 825b and, interposed therebetween, a circuit waveguide section 827 arranged in respect to the ring filter 823 so as to form a directional coupler 829. The input and output mode spot-size converters 825a and 825b are respectively coupled to an input and an output optical fiber 805a, 805b.

The optical and geometrical parameters of the waveguide 801 can for example be the same as those reported in the foregoing (Δ=6.35%, W₀=2.4 μm, h=1.8 μm, t=0.4 μm, L=240 μm, W=0.8 μm, Lₜᵢₚ=200 μm). In particular, concerning the slab height t, looking at the diagram of FIG. 4B it can be seen that better coupling efficiencies would be achieved by taking t<0.4μm, but too small slab heights would not allow achieving the coupling coefficient needed in the directional coupler 829 for particularly high bit rates applications, in respect of the technological tolerances in opening extremely narrow gaps between two waveguides. By taking t=0.4 μm, a suitable trade-off between this last aspect and the fiber-to-waveguide coupling efficiency can be reached.

The waveguide structure of FIG. 1 can be thus employed in any integrated optical component to enable high fiber coupling efficiencies and, at the same time, meet other requirements that must be satisfied.

Summarizing, the main advantages of the described waveguide structure are the capability of achieving a high coupling efficiency with an appropriate optical fiber, at the same time satisfying requirements on the waveguide characteristics different from the coupling efficiency, e.g. requirements imposed by the particular integrated optical device or devices to be formed and with which the waveguide has to interact (circuital requirements), weak influence on the coupling efficiency by tolerances on geometrical and optical parameters, low sensitivity to fiber-to-chip alignment, and selective fundamental mode excitation, even when multimode (in particular, two-mode) circuit waveguides are employed.

The described waveguide structure is particularly adapted for integrated waveguides characterized by medium to high refractive index contrast values, particularly refractive index contrast values from approximately 1% to approximately 20%. Extremely good results are achieved if the described waveguide structure is realized with materials ensuring an index contrast value from approximately 5% to approximately 7%. It is observed that these index contrast values are adapted to realize integrated optical devices for Wavelength Division Multiplexing (WDM) and Dense WDM (DWDM) communication systems. With such index contrast values, waveguides with very small bending radii can be formed, and compact devices such as ring filters (as the one shown in FIG. 8) and Mach-Zehnder interferometers with useful free spectral ranges can be obtained. By way of example, ring filters with a free spectral range of 100 GHz need bending radii lower than 300 μm, and can be realized only if the index contrast is at least equal to approximately 5%. However, the described waveguide structure can be expediently exploited also for higher refractive index contrast values, up to approximately 40%. Generalizing, the Applicant has found that the interval of refractive index contrast values for which the described waveguide structure may be exploited depends on the ratio K between the dimension of the optical field supported by the waveguide and the dimension of the external optical field to be coupled to the waveguide field: as long as this ratio is relatively low, and particularly within approximately 1 and 3, any refractive index contrast value is suitable.

The described waveguide structure is symmetrical, and can be exploited in correspondence of both optical inputs and optical outputs of integrated optical devices.

Although the present invention has been disclosed and described by way of an embodiment, it is apparent to those skilled in the art that several modifications to the described embodiments, as well as other embodiments of the present invention are possible without departing from the scope thereof as defined in the appended claims.

For example, although described making reference to the coupling between an integrated waveguide and an optical fiber, the invention can be applied in general whenever an integrated waveguide has to be coupled to an external optical field, either guided or not, and, particularly, an external optical field such that the ratio K of the dimensions thereof to the dimensions of the field supported by the integrated waveguide is relatively low, and preferably falls within the range from approximately 1 to approximately 3.

The waveguide structure according to the present invention is easy to fabricate. Thanks to the fact that only a lateral tapering of the waveguide rib core is present, the mode spot size conversion structure can be realized at the same time the rib core 113b is defined, by means of the same photolithography; no additional manufacturing steps are required compared to the manufacturing on a rib waveguide, only a peculiar layout of the photolithographic mask. This is a great advantage with respect to two-dimensional tapering known in the art, which involve more complicated processes with more steps. Alternative fabrication methods are however possible.

1-21. (canceled)

22. An integrated optical waveguide structure comprising a waveguide core for guiding an optical field, the waveguide core being formed over a lower cladding layer, wherein the waveguide core comprises a waveguide core layer substantially coextensive to the lower cladding layer and having a substantially uniform thickness, and a waveguide core rib, protruding from a surface of the waveguide core layer opposite to a surface thereof facing the lower cladding layer, said waveguide core rib having a substantially uniform height, a layout of the waveguide core rib defining a path for the guided optical field, wherein:
the integrated optical waveguide structure has a refractive index contrast of approximately 1% to approximately 40% and comprises:
a circuit waveguide portion, in which the waveguide core rib has a first width, adapted for guiding the optical field through an optical circuit; and
at least one coupling waveguide portion adapted for coupling the circuit waveguide portion to an external optical field, said coupling waveguide portion comprising:
a terminal waveguide core rib portion having a second width lower than the first width and terminating in a facet; and
a transition waveguide core rib portion optically joining to each other the core rib of the circuit waveguide portion and the terminal waveguide core rib portion, said transition waveguide core rib portion being laterally-tapered so that a width thereof decreases from the first width to the second width.

23. The integrated optical waveguide structure according to claim 22, wherein the refractive index contrast is approximately 1% to approximately 20%.

24. The integrated optical waveguide structure according to claim 22, wherein the waveguide core layer and the waveguide core rib have essentially the same refractive index.

25. The integrated optical waveguide structure according to claim 22, wherein the waveguide core is covered by an upper cladding.

26. The integrated optical waveguide structure according to claim 25, wherein the lower cladding layer has a first refractive index, the waveguide core has a second refractive index and the upper cladding has a third refractive index, the first, second and third refractive indexes being such that a refractive index contrast between the waveguide core and the lower and upper claddings is approximately 1% to approximately 20%.

27. The integrated optical waveguide structure according to claim 26, wherein said refractive index contrast is approximately 5% to approximately 7%.

28. The integrated optical waveguide structure according to claim 26, wherein said waveguide core is made of silicon oxynitride (SiON).

29. The integrated optical waveguide structure according to claim 28, wherein said lower cladding layer is made of silicon dioxide (SiO₂).

30. The integrated optical waveguide structure according to claim 28, wherein said upper cladding is made of silicon dioxide (SiO₂) gas, or air.

31. The integrated optical waveguide structure according to claim 22, wherein a ratio between the second width and the first width, and a ratio between the height of the waveguide core layer and an overall height of the waveguide core are chosen in such a way as to keep coupling losses arising when the external optical field is coupled to the integrated waveguide below a prescribed level.

32. The integrated optical waveguide structure according to claim 31, wherein at least among a value of the first width, a value of the height of the waveguide core layer and a value of the overall height of the waveguide core is chosen in such a way as to comply with requirements on the circuit waveguide portion depending on the optical circuit, and at least one among a value of the second width and a value of the height of the waveguide core layer are chosen in such a way as to achieve a prescribed efficiency in the coupling of the integrated waveguide to an external optical field having first field dimensions.

33. The integrated optical waveguide structure according to claim 32, wherein the circuit waveguide portion is designed to support an optical field of second field dimensions equal to or lower than the first field dimensions, said coupling waveguide portion performing a field dimensions adaptation for adapting the second field dimensions to the first field dimensions.

34. The integrated optical waveguide structure according to claim 33, wherein the circuit waveguide portion is designed in such a way as to support a single-mode optical field.

35. The integrated optical waveguide structure according to claim 33, wherein a ratio of the first field dimensions to the second field dimensions is approximately 1 to approximately 3.

36. The integrated optical waveguide structure according to claim 22, wherein said terminal waveguide core rib portion has a length equal to or greater than 100 μm.

37. The integrated optical waveguide structure according to claim 22, wherein a length of said transition waveguide core rib portion is chosen in dependence of a ratio between the first width and the second width so as to be at least equal to a minimum length that, expressed in microns, is given by the formula (1−W/W₀)*500.

38. The integrated optical waveguide structure according to claim 37, wherein said terminal waveguide core rib portion has a length chosen to be the shortest possible length taking account of technological tolerances in a process of separating a die in which the optical waveguide structure is integrated from other dies formed from a same wafer.

39. The integrated optical waveguide structure according to claim 37, wherein the length of the terminal waveguide core rib portion is determined, on the basis of said minimum length and of the length of the transition waveguide core rib portion, so as to be equal to a value that, expressed in microns, is given by the formula L_{tec}exp(−(L/Lₘᵢₙ)²), where L_{tec} denotes a length depending on said technological tolerances and Lₘᵢₙ is said minimum length.

40. A method of coupling an external optical field to an integrated optical waveguide of a type comprising a waveguide core for guiding an optical field, formed over a lower cladding layer, wherein the waveguide core comprises a waveguide core layer substantially coextensive to the lower cladding layer and having a substantially uniform thickness, and a waveguide core rib, protruding from a surface of the waveguide core layer opposite to a surface thereof facing the lower cladding layer, said waveguide core rib having a substantially uniform height, a layout of the waveguide core rib defining a path for the guided optical field,
the method comprising:
providing at least one coupling waveguide portion designed for coupling an external optical field to a circuit waveguide portion in which the waveguide core layer has a first width, adapted to guiding the optical field through an optical circuit, said coupling portion comprising:
a terminal waveguide core rib portion having a second width lower than the first width and terminating in a facet, and
a transition waveguide core rib portion optically joining to each other the waveguide core rib in the circuit waveguide portion and the terminal waveguide core rib portion, said transition waveguide core rib portion being laterally-tapered so that a respective width decreases from the first width to the second width, and wherein the integrated optical waveguide has a refractive index contrast from approximately 1% to approximately 40%.

41. The method according to claim 40, wherein the refractive index contrast is approximately 1% to approximately 20%.

42. The method according to claim 40, wherein the waveguide core layer and the waveguide core rib have essentially the same refractive index.

43. The method according to claim 40, wherein the waveguide core is covered by an upper cladding.

44. The method according to claim 43, wherein the lower cladding layer has a first refractive index, the waveguide core has a second refractive index and the upper cladding has a third refractive index, the first, second and third refractive indexes being such that a refractive index contrast between the waveguide core and the lower and upper claddings is approximately 1% to approximately 20%.

45. The method according to claim 40, comprising:
choosing a ratio between the second width and the first width, and a ratio between the height of the waveguide core layer and an overall height of the waveguide core in such a way as to keep coupling losses arising when the external optical field is coupled to the integrated waveguide below a prescribed level.

46. The method according to claim 45, comprising:
choosing at least one among a value of the first width, a value of the height of the waveguide core layer and a value of the overall height of the waveguide core in such a way as to comply with requirements on the circuit waveguide portion depending on the optical circuit, and
choosing at least one among a value of the second width and a value of the height of the waveguide core layer in such a way as to achieve a prescribed efficiency in the coupling of an external optical field having first field dimensions to the integrated waveguide.

47. A process for manufacturing an integrated optical waveguide structure, comprising:
forming a lower cladding layer over a substrate;
forming a waveguide core on the lower cladding layer, wherein said forming the waveguide core comprises:
forming a waveguide core layer substantially coextensive to the lower cladding layer and having substantially uniform thickness; and
forming a waveguide core rib, protruding from a surface of the waveguide core layer opposite to a surface thereof facing the lower cladding layer, said waveguide core rib having a substantially uniform height, the waveguide core rib having a layout defining a path for the guided optical field, wherein:
the integrated optical waveguide has a refractive index contrast of approximately 1% to approximately 40%; and
said forming the waveguide core rib further comprises:
forming at least one coupling waveguide portion designed for coupling an external optical field to a circuit waveguide portion in which the waveguide core rib has a first width, said forming the at least one coupling waveguide portion comprising:
forming a terminal waveguide core rib portion having a second width lower than the first width and terminating in a facet; and
forming a transition waveguide core rib portion optically joining to each other the waveguide core rib in the circuit waveguide portion and the terminal waveguide core rib portion, said transition waveguide core rib portion being laterally-tapered so that a respective width decreases from the first width to the second width.

48. The process according to claim 47, wherein the refractive index contrast is approximately 1% to approximately 20%.

49. The process according to claim 47, wherein the waveguide core layer and the waveguide core rib have essentially the same refractive index.

50. The process according to claim 47, further comprising covering the waveguide core by an upper cladding.

51. The method according to claim 50, wherein the lower cladding layer has a first refractive index, the waveguide core has a second refractive index and the upper cladding has a third refractive index, the first, second and third refractive indexes being such that a refractive index contrast between the waveguide core and the lower and upper claddings is approximately 1% to approximately 20%.

52. The process according to claim 47, wherein said forming the waveguide core comprises:
forming a material layer over the lower cladding layer; and
selectively removing the material layer to define the waveguide core layer and the waveguide core rib.

53. The process according to claim 52, wherein the terminal portion and the transition portion are formed simultaneously with said forming of the waveguide core rib.
